(19) United States
(12) Patent Application Publication
(10) Pub. No.: US 2013/0054742 A1
(43) Pub. Date: Feb. 28, 2013

(54) CONTENT PROCESSOR

(71) Applicants: Masashi Tsuji, Tokyo (JP); Naozumi Koshino, Saitama (JP); Kazuaki Iwamura, Tokyo (JP); Yoshihiro Ohmori, Tokyo (JP)

(72) Inventors: Masashi Tsuji, Tokyo (JP); Naozumi Koshino, Saitama (JP); Kazuaki Iwamura, Tokyo (JP); Yoshihiro Ohmori, Tokyo (JP)

(21) Appl. No.: 13/473,306

(22) Filed: May 16, 2012

(30) Foreign Application Priority Data
Aug. 26, 2011 (JP) 2011-185166

(51) Int. Cl. G06F 15/16

(52) U.S. Cl. 709/217

(57) ABSTRACT

According to one embodiment, a content processor includes: an information acquiring module; a determining module; a resume information acquiring module; a content request module; and a content acquiring module. The information acquiring module acquires, from a content sending device, command information representing a command executable by the content sending device. The determining module is configured to determine whether the content sending device is provided with a resume function for the content based on the command information. The resume information acquiring module acquires, if the determining module determines that the content sending device is provided with the resume function, resume information indicating a point where the content is stopped, from the content sending device. The content request module outputs a request for transferring the content from the point. The content acquiring module acquires, from the content sending device, the content transferred from the point.

### CROSS-REFERENCE TO RELATED APPLICATIONS

This application is based upon and claims the benefit of priority from Japanese Patent Application No. 2011-185166, filed on Aug. 26, 2011, the entire contents of which are incorporated herein by reference.

### FIELD

Embodiments described herein relate generally to a content processor.

### BACKGROUND

Recently, there is a trend to use electronic devices that support the universal plug and play (UPnP™) AV standard and the digital living network alliance (DLNA) guidelines. The UPnP™ AV standard is a protocol to reproduce AV content and the like as an upper layer of the UPnP™ protocol that allows an electronic device to join a network by only connecting the device to the network. The DLNA guidelines are an industry standard that ensures compatibility between electronic devices and establishes a network of in-home electronic devices. The DLNA guidelines use the UPnP™ protocol as the process of communication between the electronic devices.

The use of the UPnP™ AV standard enables the transfer of content such as video and music managed by one device to another in a home network such as an in-home local area network (LAN) to reproduce the content on the other device.

In the case where a digital media player (DMP) reproduces content provided from a digital media server (DMS) that manages content, after the DMP stops reproducing the content at a point, it is difficult to reproduce the content from the point with a different DMP. In view of this, there has been proposed a technology to realize content resume function for devices that support the UPnP™ AV standard.

The conventional technology only proposes the resume function, and application of the resume function to real devices may cause problems.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration of a home network that connects devices according to a first embodiment;

FIG. 2 is an exemplary block diagram of a main signal processing system of a digital television (TV) display device as an example of a digital media player (DMP) and a digital media server (DMS) in the first embodiment;

FIG. 3 is an exemplary block diagram of a software configuration of the DMP in the first embodiment;

FIG. 4 is an exemplary schematic diagram of a “Service Description” in the first embodiment;

FIG. 5 is an exemplary block diagram of a software configuration of the DMS in the first embodiment;

FIG. 6 is an exemplary schematic diagram of a table structure of a resume table stored in a content information storage module in the first embodiment;

FIG. 7 is an exemplary flowchart of the operation of the DMP in the first embodiment;

FIG. 8 is an exemplary sequence diagram of the process of reproducing content from a resume position in the DMP and the DMS in the first embodiment;

FIG. 9 is an exemplary schematic diagram of a “CDS:X_GetResumePoint” request in the first embodiment;

FIG. 10 is an exemplary schematic diagram of a “ResumePoint” response including resume information in the first embodiment;

FIG. 11 is an exemplary sequence diagram of the specific process of stopping content in the DMP and the DMS in the first embodiment;

FIG. 12 is an exemplary schematic diagram of a “X_SetResumePoint” request in the first embodiment;

FIG. 13 is an exemplary schematic diagram of a “OK” response to the “X_SetResumePoint” request in the first embodiment;

FIG. 14 is an exemplary schematic diagram of a configuration of a home network that connects devices according to a second embodiment;

FIG. 15 is an exemplary block diagram of a software configuration of a digital media controller (DMC) in the second embodiment;

FIG. 16 is an exemplary schematic diagram of a content list displayed by a display controller in the second embodiment;

FIG. 17 is an exemplary schematic diagram of an “AVT:Seek” action in the second embodiment;

FIG. 18 is an exemplary schematic diagram of a response to the “AVT: Seek” action in the second embodiment;

FIG. 19 is an exemplary flowchart of the operation of the DMC in the second embodiment;

FIG. 20 is an exemplary schematic diagram of a configuration of a home network that connects devices according to a third embodiment;

FIG. 21 is an exemplary block diagram of a software configuration of a DMP in the third embodiment;

FIG. 22 is an exemplary schematic diagram of a list of devices displayed by a display controller in the third embodiment; and

FIG. 23 is an exemplary schematic diagram of a configuration of a home network that connects devices according to a fourth embodiment.

### DETAILED DESCRIPTION

In general, according to one embodiment, a content processor comprises: an information acquiring module; a determining module; a resume information acquiring module; a content request module; and a content acquiring module. The information acquiring module is configured to acquire, from a content sending device configured to provide a content by a universal plug and play (UPnP) function, command information representing a command executable by the content sending device. The determining module is configured to determine whether the content sending device is provided with a resume function for the content based on the command information. The resume information acquiring module is configured to acquire, if the determining module determines that the content sending device is provided with the resume function, resume information indicating a point where the content being played is stopped, from the content sending device. The content request module is configured to output a request for transferring the content from the point indicated by the resume information acquired by the resume information acquiring module. The content acquiring module is configured to acquire, from the content sending device, the content transferred from the point.

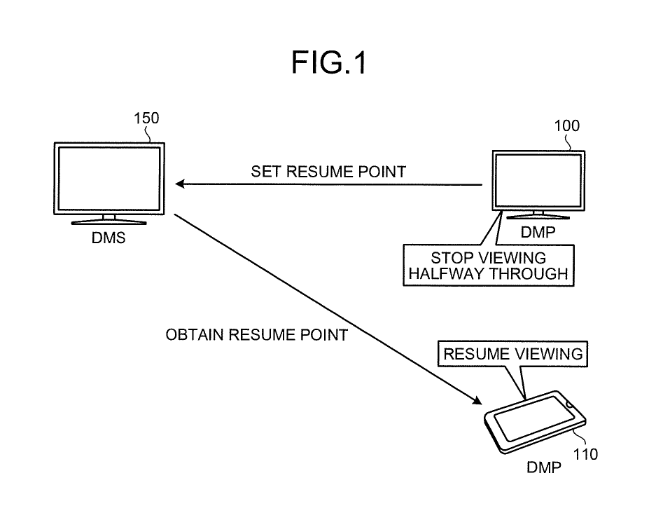

FIG. 1 is a schematic diagram of a configuration of a home network that connects devices according to a first embodiment. As illustrated in FIG. 1, the home network comprises a digital media server (DMS) 150, a digital media player (DMP) 100, and a DMP 110. In the first embodiment, a 2-Box System will be described that comprises DMS and DMP.

While, in the first embodiment, universal plug and play (UPnP)/digital living network alliance (DLNA) technology is described as being applied, this is by way of example and not of limitation. Other technologies may also be applicable. As illustrated in FIG. 1, the DMS 150 and the DMPs 100 and 110 are connected via a network and are communicable with one another.

The DMS 150 stores content and provides the content to other devices. The DMPs 100 and 110 detect the DMS 150 in the network by the UPnP device detection function. The DMPs 100 and 110 receive selection of content provided by the DMS 150 from the user and receive the selected content from the DMS 150, thereby reproducing the content.

UPnP does not define the function of setting a resume point for content as well as the function of obtaining the resume point. Accordingly, the resume function cannot be used via UPnP. Consequently, for example, if a DMP stops playing content at a point in the middle, it is difficult to play the content from that point by another DMP. In recent years, there has been proposed a resume function for DMS and DMP; however, all devices in the home network need to be compatible with the resume function.

Thus, according to the first embodiment, the DMPs 100 and 110 are configured to first determine whether each device is compatible with the resume function, and then uses the resume function. This allows the user to view content provided from the DMS 150 halfway through on the DMP 100 and view the rest on the DMP 110. In the following, a hardware configuration of each device will be described.

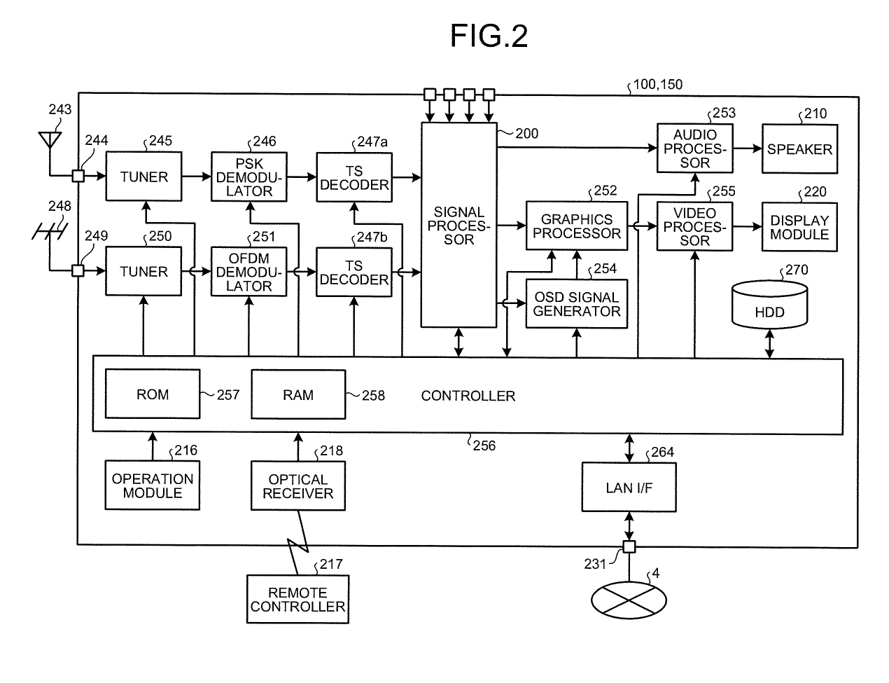

In the first embodiment, the DMS 150 and the DMP 100 are each described as, for example, a digital television (TV) display device. A description will be given of a hardware configuration of the DMS 150 and the DMP 100 of the first embodiment. FIG. 2 is a block diagram of a main signal processing system of a digital TV display device as an example of the DMP 100 and the DMS 150 of the first embodiment.

As illustrated in FIG. 2, when an antenna 243 for receiving broadcast satellite/communication satellite (BS/CS) digital broadcasting receives a satellite digital TV broadcast signal, the broadcast signal is fed via an input terminal 244 to a tuner 245 for satellite digital broadcasting.

According to a control signal from a controller 256, the tuner 245 selects a desired channel, and then outputs a broadcast signal from the selected channel to a phase shift keying (PSK) demodulator 246.

The PSK demodulator 246 demodulates the broadcast signal received from the tuner 245 according to a control signal from the controller 256. Thus, the PSK demodulator 246 acquires a transport stream (TS) containing a desired program, and outputs it to a TS decoder 247a.

The TS decoder 247a performs TS decoding on a multiplexed TS signal according to a control signal from the controller 256. The TS decoder 247a also depacketizes digital video and audio signals of the desired program to obtain a packetized elementary stream (PES). The TS decoder 247a then outputs the PES to an system target decoder (STD) buffer (not illustrated) in a signal processor 200.

On the other hand, when an antenna 248 for receiving digital terrestrial broadcasting receives a digital terrestrial TV broadcast signal, the broadcast signal is fed via an input terminal 249 to a tuner 250 for digital terrestrial broadcasting.

According to a control signal from the controller 256, the tuner 250 selects a desired channel, and outputs a broadcast signal from the selected channel to an orthogonal frequency division multiplexing (OFDM) demodulator 251.

The OFDM demodulator 251 demodulates the broadcast signal received from the tuner 250 according to a control signal from the controller 256. Thus, the OFDM demodulator 251 acquires a transport stream containing a desired program, and outputs it to a TS decoder 247b.

The TS decoder 247b performs TS decoding on a multiplexed TS signal according to a control signal from the controller 256. The TS decoder 247b also depacketizes digital video and audio signals of the desired program to obtain a PES. The TS decoder 247b then outputs the PES to the STD buffer in the signal processor 200. In addition, the TS decoder 247b sends section information transmitted through digital broadcasting to a section processor in the signal processor 200.

While the user is viewing a TV program, the signal processor 200 selectively performs predetermined digital signal processing on the digital video and audio signals received from the TS decoder 247a and those received from the TS decoder 247b. Then, the signal processor 200 outputs the video signal to a graphics processor 252 and the audio signal to an audio processor 253. While a program is being recorded, the signal processor 200 selectively performs predetermined digital signal processing on the digital video and audio signals received from the TS decoder 247a and those received from the TS decoder 247b. Then, the signal processor 200 stores the signals in a hard disk drive (HDD) 270 through the controller 256. While a recorded program is being reproduced, the signal processor 200 performs predetermined digital signal processing on data of the recorded program read from the HDD 270 through the controller 256. The signal processor 200 outputs the data to the graphics processor 252 and the audio processor 253.

The controller 256 receives various types of data for obtaining a program from the signal processor 200, such as key information for BS conditional access system (B-CAS) descrambling, electronic program guide (EPG) information, program attribute information (program category, etc.), closed caption information including program specific information (PSI) and service information (SI), and the like. The controller 256 generates image information from these pieces of information to display EPG, closed captions, and the like, and outputs the image information to the graphics processor 252.

Besides, the controller 256 has the function of controlling the recording and scheduled or timer recording of a program. When a user programs the recording of a program, the controller 256 displays EPG information on a display module 220. Upon receipt of an input from the user through an operation module 216 or a remote controller 217, the controller 256 stores information specified by the user in a predetermined storage module. Thus, the controller 256 controls the tuners 245 and 250, the PSK demodulator 246, the OFDM demodulator 251, the TS decoders 247a and 247b, and the signal processor 200 so that a specified program is to be recorded during a specified time period.

The graphics processor 252 synthesizes the following signals: (1) a digital video signal fed from an AV decoder (not illustrated) in the signal processor 200, (2) an on-screen display (OSD) signal generated by an OSD signal generator 254, (3) image data of data broadcasting, and (4) EPG and closed caption signals generated by the controller 256. The graphics processor 252 outputs the synthesized signals to a video processor 255.

To display a close-captioned program with closed captions, the graphics processor 252 overlays closed caption information from the controller 256 on a video signal under the control of the controller 256.

The digital video signal output from the graphics processor 252 is fed to the video processor 255.

The video processor 255 converts the input digital video signal to an analog video signal of a format displayable by the display module 220, and thereafter, output the analog video signal to the display module 220 to display the video.

The audio processor 253 converts the input digital video signal to an analog audio signal of a format playable by a speaker 210, and output the analog audio signal to the speaker 210 to play the audio.

Here, the entire operation of the DMS 150 and DMP 100, including the various aforementioned receiving operations, are controlled by the controller 256. The controller 256 comprises a built-in central processing unit (CPU), and receives operation information from the operating module 216 or receives the operation information sent from the remote controller 217 via the receiver 218 so as to control each element to reflect the operation content.

In this case, the controller 256 mainly utilizes a read only memory (ROM) 257 storing therein a control program to be executed by the CPU thereof and a random access memory (ROM) 258 providing a work space for the CPU.

Further, the controller 256 is connected to a local area network (LAN) terminal 231 via an I/F 264. Consequently, the controller 256 can transmits information with respect to an external device via a home network 4 connected via the LAN terminal 231.

The hardware configuration of the DMP 100 and the DMS 150 are not limited to the television display device, and other configurations may be applied. For example, the DMP 110 is applied to a portable terminal, and a main internal signal processing system comprises a hardware configuration the same as the PC, thereby the explanation thereof is omitted.

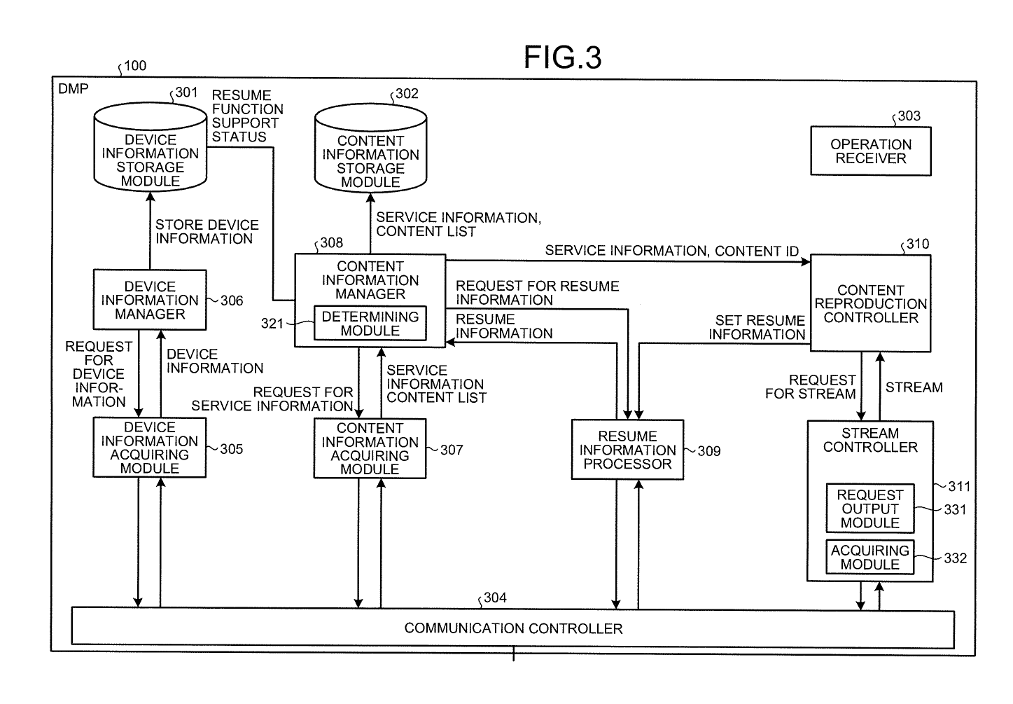

FIG. 3 is a block diagram of a software configuration of the DMP 100 according to the present embodiment. As illustrated in FIG. 3, the DMP 100 comprises: a device information storage module 301; a content information storage module 302; a operation receiver 303; a communication controller 304; a device information acquiring module 305; a device information manager 306; a content information acquiring module 307; a content information manager 308; a resume information processor 309; a content reproduction controller 310; and a stream controller 311. Here, the DMP 110 is assumed to comprise the same software configuration, and explanations thereof are omitted.

The device information storage module 301 stores therein device information acquired from other communication devices (for example, the DMS 150). The device information is comprised in, for example, “Device Description” sent from the DMS 150.

The content information storage module 302 stores therein information related to a content. For example, the content information storage module 302 stores therein service information acquired from other communication devices (for example, DMS 150). The service information is comprised in, for example, “Service Description” sent from the DMS 150.

The operation receiver 303 receives operations from the operation module 216 and/or the remote controller 217 illustrated in FIG. 2.

The communication controller 304 controls sending and receiving data with respect to other device connected via the home network.

The communication controller 304 receives the “Device Description” from the DMS 150 detected by the device find function by the UPnP. At this time, the device information acquiring module 305 acquires the device information contained in the “Device Description”. The “Device Description” may be conventionally used data.

The device information manager 306 manages the device information acquired by the device information acquiring module 305. Then, when necessary, the device information manager 306 performs reading and writing of the device information with respect to the device information storage module 301. Consequently, the device information manager 306 can recognize from the acquired device information that the DMS 150 sending the “Device Description” is a media server.

The communication controller 304 receives the “Service Description” from the DMS 150. At this time, the content information acquiring module 307 acquires the service information contained in the received “Service Description”.

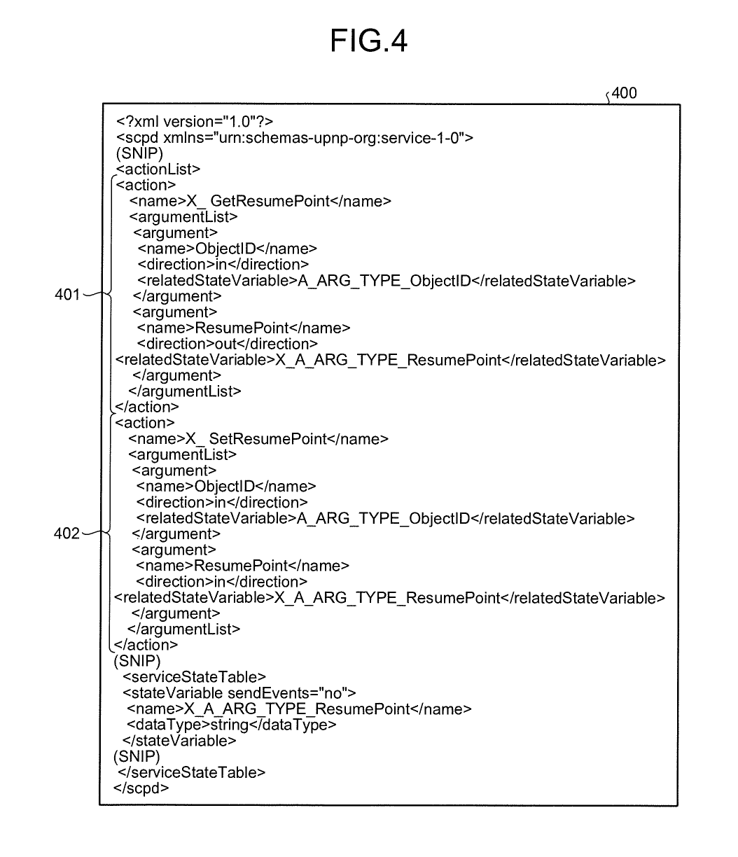

FIG. 4 is a diagram illustrating an example of the “Service Description”. As illustrated in FIG. 4, the “Service Description” 400 contains usable actions (commands) within the “actionList”. For example, the tag “action” 401 contains information related to the action “X_GetResumePoint”. Further, the tag “action” 402 contains information related to the action “X_SetResumePoint”.

The action “X_GetResumePoint” is defined to be a command for acquiring a resume point of a predetermined content.

The action “X_SetResumePoint” is defined to be a command for setting a resume point of a predetermined content.

That is to say, since the “Service Description” contains the action “X_GetResumePoint” and the action “X_SetResumePoint”, it can be recognized that the DMS 150 has the resume function. Here, the “Service Description” does not have to contain both of the action “X_GetResumePoint” and the action “X_SetResumePoint” so that the DMS 150 is to be recognized as having the resume function, and the “Service Description” may contain one of the actions so that the DMS 150 is recognized as having the resume function.

Furthermore, the content information acquiring module 307 acquires a list of content provided by the DMS 150 from the DMS 150.

The content information manager 308 comprises a determining module 321, and manages the service information acquired by the content information acquiring module 307. Then, if necessary, the content information manager 308 reads and writes the service information with respect to the content information storage module 302.

Further, the content information manager 308 manages a list of content acquired by the content information acquiring module 307. Still further, if necessary, the content information manager 308 reads and writes the list of content with respect to the content information storage module 302. Still further, the content information manager 308 instructs the display controller not illustrated to display the list of content.

Based on the “Service Description” received by the content information acquiring module 307, the determining module 321 determines whether the DMS 150 provides the resume function of content. The determining module 321 according to the present embodiment determines that the DMS 150 provides the resume function of content if the “Service Description” received from the DMS 150 contains at least one of the action “X_GetResumePoint” and the action “X_SetResumePoint”.

If the determining module 321 determines that the DMS 150 provides the resume function, the resume information processor 309 acquires resume information for the content to be viewed, from the DMS 150. The resume information is information containing a point where the content to be viewed is stopped. In the present embodiment, the resume information can be acquired by using the action “X_GetResumePoint”.

The stream controller 311 comprises a request output module 331 and an acquiring module 332, and controls a stream transferred from the DMS 150.

The request output module 331 requests the DMS 150 to transfer the content to be viewed. At this time, the request output module 331 requests the DMS 150 to transfer the content from the resume point, which is contained in the resume information acquired by the resume information processor 309.

In accordance with the aforementioned requests, the acquiring module 332 acquires the content transferred from the resume point from the DMS 150 via the communication controller 304.

The content reproduction controller 310 controls playing of the content acquired by the acquiring module 332.

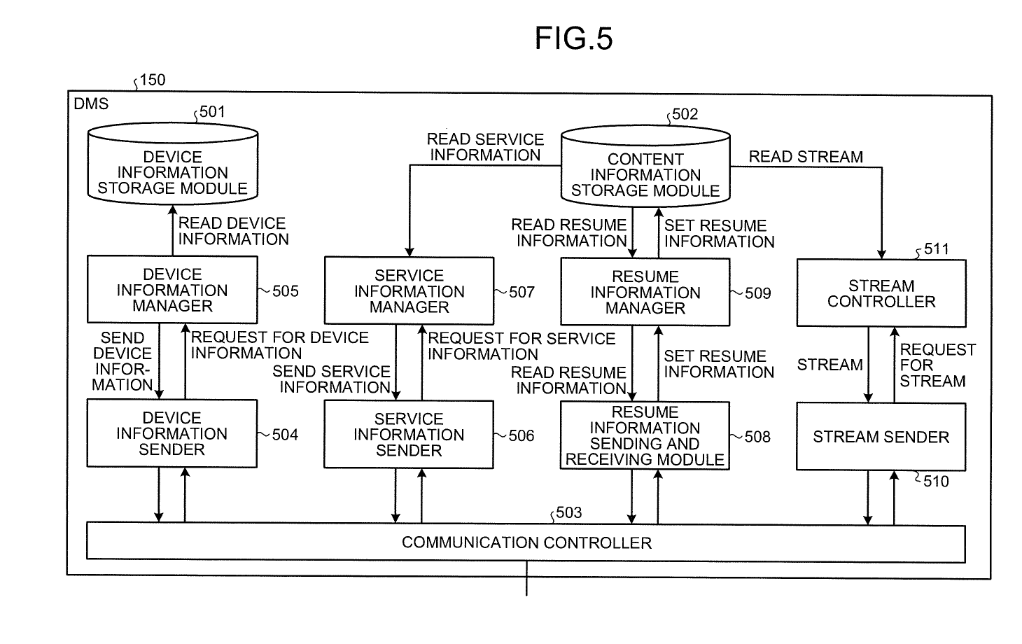

FIG. 5 is a block diagram of a software configuration of the DMS 150 according to the present embodiment. As illustrated in FIG. 5, the DMS 150 comprises a device information storage module 501, a content information storage module 502, a communication controller 503, a device information sender 504, a device information manager 505, a service information sender 506, a service information manager 507, a resume information sending and receiving module 508, a resume information manager 509, a stream sender 510, and a stream controller 511.

The device information storage module 501 stores therein device information representing a main body of the DMS 150 and to be provided to other devices.

The communication controller 503 controls sending and receiving data with respect to other devices connected thereto via the home network.

The device information manager 505 manages the device information stored in the device information storage module 501. In response to a request from other devices, the device information manager 505 reads the device information from the device information storage module 501, and passes the device information to the device information sender 504.

The device information sender 504 sends the “Device Description” containing the device information to other device which has requested for the “Device Description”, via the communication controller 503.

The content information storage module 502 stores therein service information, which is information related to a service provided by the DMS 150 and contains information on actions (commands) that can be provided to other devices.

Further, the content information storage module 502 stores therein the content to be provided to the other device. Still further, the content information storage module 502 stores therein the resume point for each content.

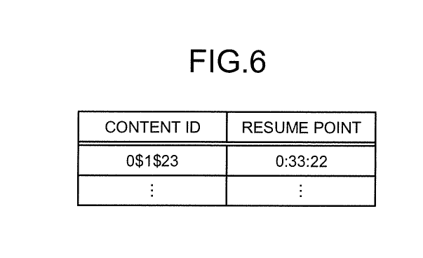

FIG. 6 is a diagram of a table configuration of a resume table stored in the content information storage module 502 according to the present embodiment. As illustrated in FIG. 6, in the resume table, the content ID and the resume point are associated with each other. As illustrated in FIG. 6, since the content information storage module 502 stores therein resume points each of which is unique to each of the contents, the DMS 150 can provide the resume point in response to a request from other devices.

The service information contains actions or the like which can be provided by the DMS 150. In the present embodiment, the service information contains at least one of the action “X_GetResumePoint” and the action “X_SetResumePoint”.

The service information manager 507 manages the service information stored in the content information storage module 502. In response to the request from other devices, the service information manager 507 reads out the service information from the content information storage module 502, and passes the service information to the service information sender 506.

The service information sender 506 sends, via the communication controller 503, the “Service Description” containing the service information to the other device which has requested for the “Service Description”.

The resume information manager 509 manages the service information stored in the content information storage module 502. In response to the request for the resume point received from the other device together with the content ID, the resume information manager 509 reads out the resume point associated with the received content ID from the content information storage module 502, and passes the resume point to the resume information sending and receiving module 508.

The resume information sending and receiving module 508 sends the resume information containing the passed resume point to a device which has sent the request for the resume point (for example, DMP 100).

The resume information sending and receiving module 508 receives resume information comprising the resume point of the content which had been played, from other device (for example, DMP 100). The received resume information comprises a content ID, in addition to the resume point. Then, the resume information sending and receiving module 508 passes the resume point and the content ID to the resume information manager 509.

Then, if the resume information manager 509 receives the resume point and the content ID, the resume information manager 509 updates the resume table stored in the content information storage module 502 by the received resume point and the content ID in associated manner. Consequently, the DMS 150 according to the present embodiment can manage the resume point which represents a point where the content is stopped in other device.

The stream controller 511 controls the stream of content stored in the content information storage module 502. In response to a transfer request for the stream from other device, the stream controller 511 reads the stream from the content information storage module 502, and passes the stream to the stream sender 510. If the transfer request contains the resume point, the stream controller 511 passes the stream of content from the resume point.

The stream sender 510 sends the stream of content received from the stream controller 511 to a device which has requested for content transfer via the communication controller 503.

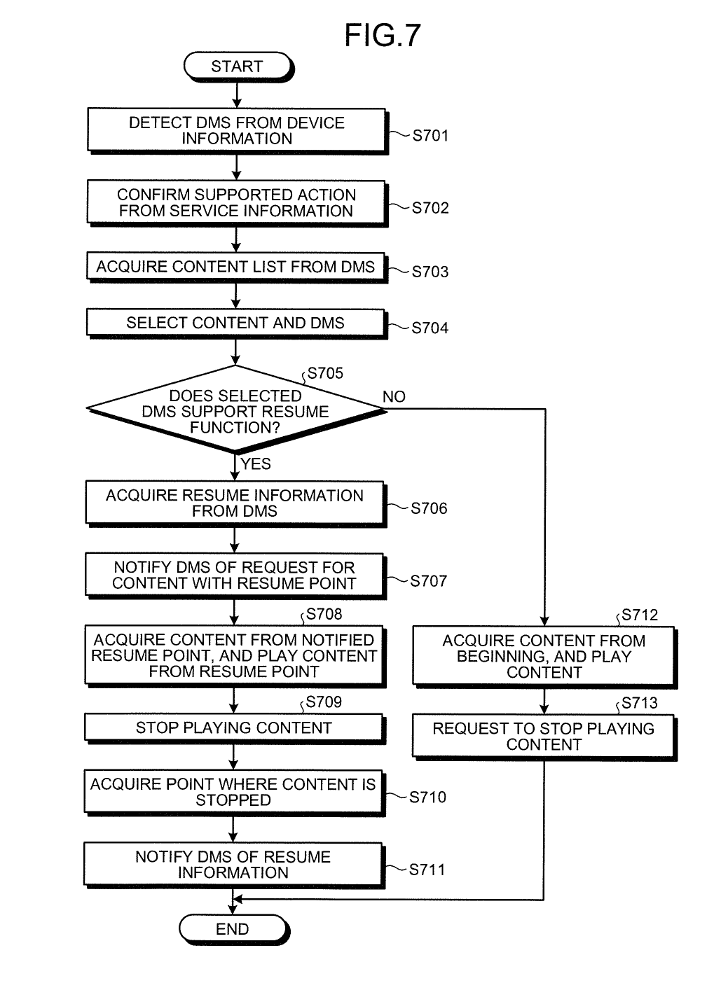

Overall process in the DMP 100 according to the present embodiment is explained next. FIG. 7 is a flowchart of above-mentioned process in the DMP 100 according to the present embodiment.

First, the device information acquiring module 305 of the DMP 100 detects the DMS 150 from the acquired device information (S701). Next, the content information acquiring module 307 requests the detected DMS 150 for the service information via the communication controller 304. Consequently, the content information acquiring module 307 acquires the service information, and passes the service information to the content information manager 308.

Then, based on the received service information, the content information manager 308 confirms the action supported by the detected DMS 150 (S702). The content information manager 308 then manages the confirmed action in association with the DMS 150.

If it is confirmed that the content can be acquired from the DMS 150, the content information acquiring module 307 acquires the content list from the DMS 150 (S703). Then, the content information manager 308 manages the acquired content list in association with the DMS 150.

When necessary, the detected DMS 150 and the content list managed by the content information manager 308 is displayed. Then, the operation receiver 303 receives selection of a content desired to be viewed and the DMS (for example, DMS 150) from a user (S704).

The selection of the content is not limited to the aforementioned method. That is to say, a user may search through the DMS 150 by using functions of the DMP 100 via the operation receiver 303 to detect and select a content desired to be viewed.

The DMS 150 which sends the content may be directly selected by a user when the content is selected by the user. On the other hand, the DMS 150, which holds the content to be selected by the user, may automatically be selected when the user selects the content. Furthermore, the content may be limited to be received if the content is held by the DMS which is preliminarily selected before the user selects the content.

When the DMS is automatically selected based on the selected content, there is a possibility that there exists a plurality of such DMSs managing the same content. In such case, a user may select a particular DMS 150, or the DMP 100 may automatically select a DMS 150 which can use the resume function.

The determining module 321 determines whether the resume function is supported by the DMS 150 based on the action managed in association with the selected DMS 150 (S705).

If the determining module 321 determines that the DMS 150 does not support the resume function (No at S705), the content information manager 308 passes the service information and the content ID to the content reproduction controller 310. Accordingly, in response to an instruction from the content reproduction controller 310, the stream controller 311 requests the DMS 150 for the content of the received content ID from the beginning of the content. The stream controller 311 then acquires the stream of content from the beginning, and passes the stream of content to the content reproduction controller 310. Then, the content reproduction controller 310 plays the stream of content (S712).

If the operation receiver 303 receives an operation to stop the content, the stream controller 311 requests the DMS 150 to stop playing the stream of content (S713). Accordingly, the transferring of the content is stopped.

On the other hand, if the determining module 321 determines that the DMS 150 supports the resume function (Yes at S705), the resume information processor 309 requests the DMS 150 for the resume information, using the action “X_GetResumePoint”. Accordingly, the resume information processor 309 acquires the resume information from the DMS 150 (S706). Then, the resume information is passed to the content information manager 308. The content information manager 308 passes the resume information to the content reproduction controller 310, together with the service information and the content ID. Accordingly, the content reproduction controller 310 requests the stream controller 311 for the stream.

The request output module 331 of the stream controller 311 notifies the DMS 150 of the request for the content with the resume point at which the content is to be played (S707). In the present embodiment, the resume point is assigned to the RANGE header of the HTTP GET request.

Then, from the DMS 150 via the communication controller 304, the acquiring module 332 acquires the content from the resume point, and the content reproduction controller 310 plays the content from the resume point (S708).

If the operation receiver 303 receives an operation to stop playing the content, the stream controller 311 stops playing the stream of content (S709). Consequently, the transferring of the content which is being played is stopped.

The resume information processor 309 then acquires the resume information containing a point at which the content is stopped, from the content reproduction controller 310 (S710).

Then, the resume information processor 309 notifies the DMS 150 of the request for setting the resume, together with the acquired resume information (S711).

By the aforementioned process, it becomes possible to play the content from the resume point, and also to set the resume point after playing the content. Furthermore, by the aforementioned process, it is determined whether the resume function is supported. Consequently, it becomes possible to inquire the resume information only from the DMS 150 supporting the resume function. Thus, without changing a user procedure, the content can be played quickly from the resume point, even in the environment that a DMS 150 supporting the resume function and a DMS 150 not supporting the resume function coexist.

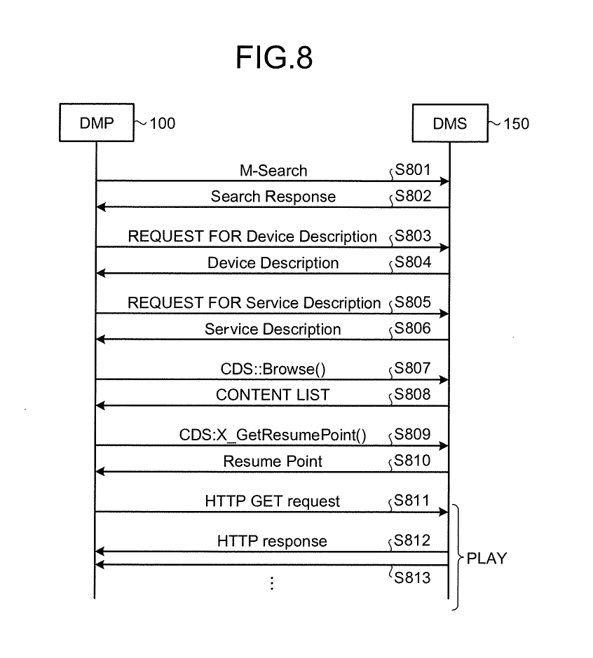

Next, a detailed process for playing the content from the resume point is explained. FIG. 8 is a sequence diagram of the aforementioned process in the DMP 100 and the DMS 150 according to the present embodiment. The sequence diagram illustrates the process from S701 to S708 in FIG. 7.

First, the device information acquiring module 305 of the DMP 100 sends the message “M-Search” by the multicast (S801). As a response to the message, the DMS 150 sends back the “Search Response” to the DMP 100 (S802).

Then, the device information acquiring module 305 of the DMP 100 requests the DMS 150, which sent back the response, for the “Device Description” containing the device information (S803). Accordingly, the DMS 150 sends the “Device Description” to the DMP 100 (S804). Thus, the device information acquiring module 305 can acquire the “Device Description” containing the device information. Consequently, the DMP 100 can recognize the DMS 150 as a device which provides the content.

The content information acquiring module 307 of the DMP 100 requests for the “Service Description”, which is the service information (S805). Then, the DMS 150 sends the “Service Description” to the DMP 100 (S806). Accordingly, the content information acquiring module 307 can acquire the “Service Description” as the service information. Thus, the DMP 100 can recognize the action provided by the DMS 150.

Then, the content information acquiring module 307 of the DMP 100 sends a request “CDS: Browse” (S807). The request “CDS: Browse” is a request for the list of user meta data, and in the present embodiment, it is a request for the content list.

In response to the request, the DMS 150 sends the content list to the DMP 100 (S808). The content list contains a content name and a content ID, for each content.

Therefore, it becomes capable for the DMP 100 to receive the selection of content provided by the DMS 150. Here, it is assumed that the content selection is received from a user.

Subsequently, the resume information processor 309 of the DMP 100 sends the request “CDS: X_GetResumePoint” to the DMS 150 (S809).

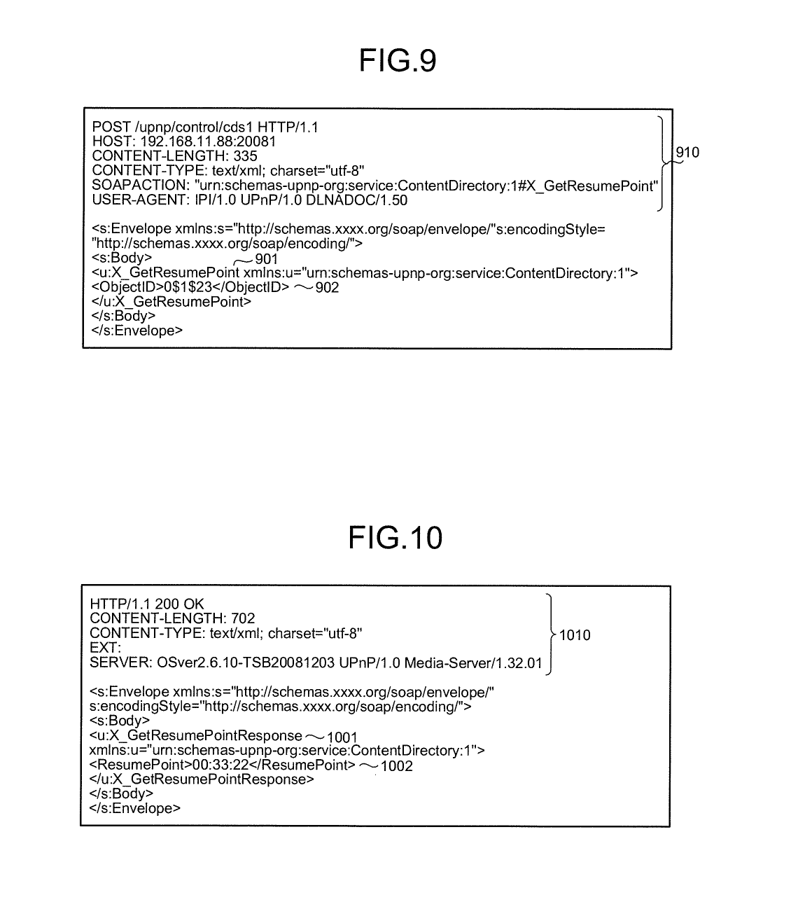

FIG. 9 is a diagram illustrating an example of the request “CDS: X_GetResumePoint”. As illustrated in FIG. 9, the request is configured by a header 910 and a body in extensible markup language (XML). Within the tag “u”, it is indicated that the action is “GetResumePoint” 901. Further, a content ID which is a target from which the resume information is acquired is embedded within the tag “ObjectID” 902.

The DMS 150 which has received the request sends the “ResumePoint” containing the resume information indicating the resume point corresponding to the object ID (S810). Upon receipt of the resume information and when the resume information processor 309 acquires the resume information, the resume information processor 309 can recognize the resume point.

FIG. 10 is a diagram illustrating an example of the response “ResumePoint” containing the resume information. As illustrated in FIG. 10, the response “ResumePoint” containing the resume information is configured by a header 1010 and a body in the XML. Within the tag “u”, it is indicated that the action is “GetResumePointResponse” 1001. The resume point is embedded in the tag “ResumePoint” 1002.

The request output module 331 of the DMP 100 sends the HTTP GET request in which the resume point from which the content is to be played is contained in the Range header is sent to the DMS 150 (S811).

In response, the DMS 150 transfers the content from the resume point as a response to the HTTP (S812 to S813).

By the aforementioned process, it becomes possible to play the content from the resume point.

Then, the request output module 331 of the DMP 100 sends the HTTP GET request in which the resume point from which the content is to be played is contained in the RANGE header is sent to the DMS 150 (S811).

In response, the DMS 150 transfers the content from the resume point, as a response of the HTTP (S812 to S813). Consequently, it becomes possible in the DMP 100 to play the content from the resume point.

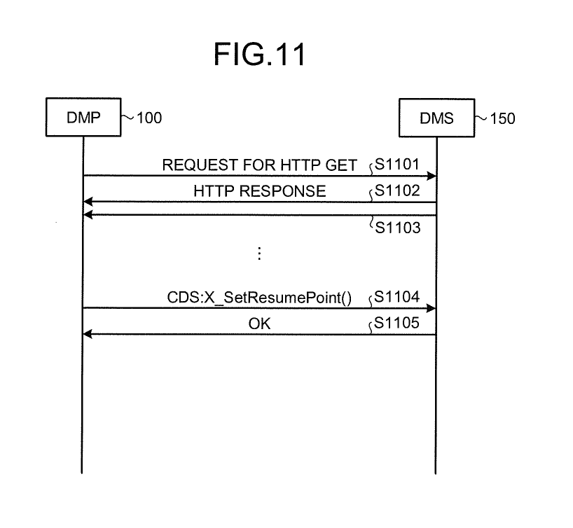

Next, a detailed process of when the content is stopped is explained. FIG. 11 is a sequence diagram of the aforementioned process of the DMP 100 and the DMS 150 according to the present embodiment. Here, the sequence diagram illustrates a flow of process from S708 to S711 in FIG. 7.

Following FIG. 10, the request output module 331 of the DMP 100 sends the HTTP GET request to the DMS 150 (S1101). In response, the DMS 150 sends the content as a response of the HTTP (S1102 to S1103).

Then, the DMP 100 stops playing the stream. Accordingly, the transferring of the streaming from the DMS 150 is stopped. Then, the resume information processor 309 acquires a point where the streaming is stopped (resume point).

The DMP 100 then sends the request “CDS: X_SetResumePoint” for setting the resume point, to the DMS 150 (S1104).

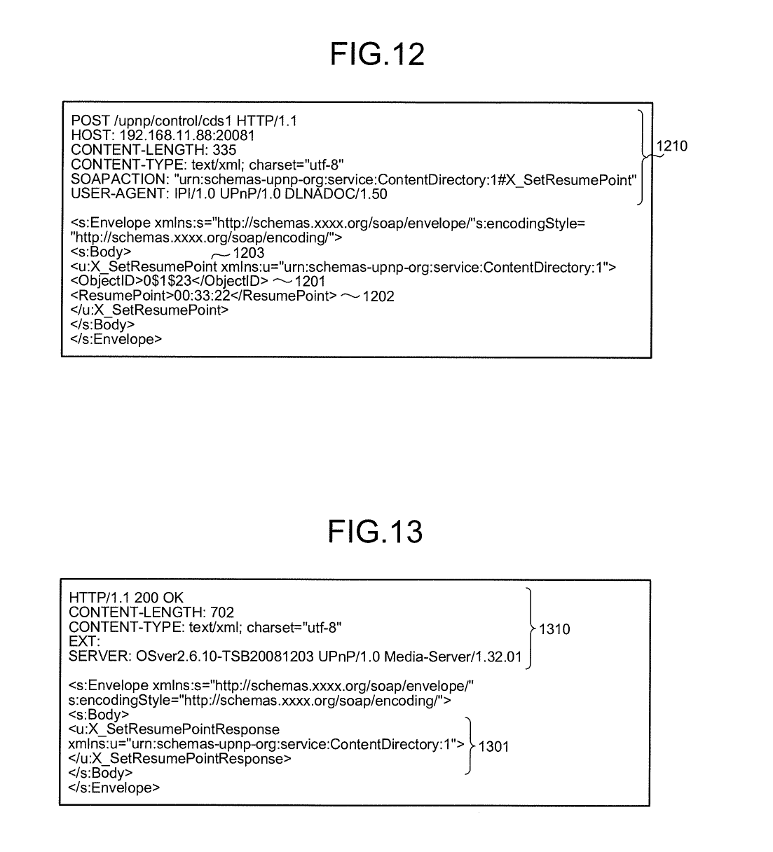

FIG. 12 is a diagram illustrating an example of the request “X_SetResumePoint”. As illustrated in FIG. 12, the request is configured by a header 1210 and a body in the XML. Within the tag “u”, it is indicated that the action is “X_SetResumePoint” 1203. The content ID, the resume point of which is to be set, is embedded in the tag “ObjectID” 1201. Further, the resume point “00:33:22” to be set is embedded in the tag “ResumePoint” 1202.

Upon receipt of the request, the resume information manager 509 of the DMS 150 registers, in the content information storage module 502, the resume point contained in the request in association with the content ID.

Then, the DMS 150 notifies the DMP 100 of a response that the “X_SetResumePoint” is “OK” (S1105).

FIG. 13 is a diagram illustrating an example of the response that the “X_SetResumePoint” is “OK”. As illustrated in FIG. 13, the request is configured by a header 1310 and a body in the XML. Within the tag “u”, it is indicated that the action is the “SetResumePointResponse” 1301.

According to the aforementioned process, the DMS 150 can manage the resume point in association with the content played.

The DMS 150 according to the present embodiment can play the content by itself. The DMS 150 stores the resume point for each content, irrespectively of whether the content is played by other device or the DMS 150 itself. Consequently, it becomes possible to play the resumed content irrespectively of a device used for viewing (for example, the DMS 150 or the DMPs 100, 110).

If the resume point is updated only when the content is stopped, it might become the case that the resume point cannot be set due to the network shutdown during playing of the content. Thus, the resume information may be updated by constantly executing the action “X_SetResumePoint” for setting the resume point during the playing of the content. Consequently, the resumed content can be played without being aware of a terminal playing the content.

In the first embodiment, the 2-BOX system is explained. However, it is not limited to the 2 BOX system. Thus, in a second embodiment, 3-BOX system is explained. In the 3-BOX system, a digital media renderer (DMR) and a digital media server (DMS) are controlled using a digital media controller (DMC) by the UPnP/DLNA technology.

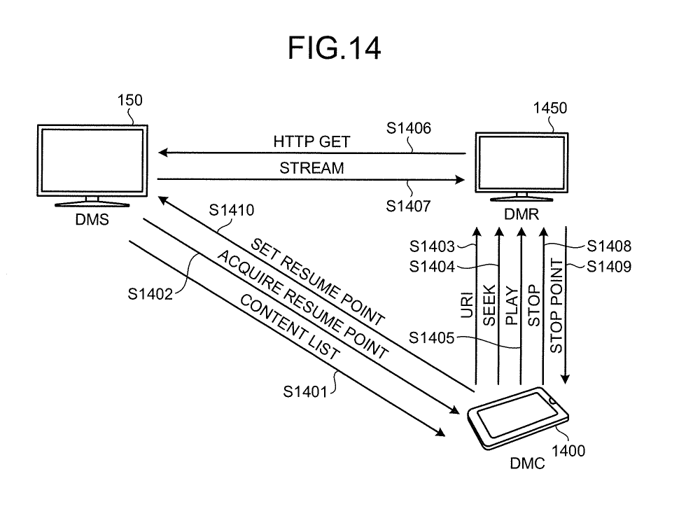

FIG. 14 is a diagram illustrating a home network configuration connecting devices with each other, according to the second embodiment. As illustrated in FIG. 14, the present embodiment is configured by a DMS 150, DMC 1400, and a DMR 1450. Configurations the same as that of the first embodiment are referred to by the same reference numerals, and the explanations thereof are omitted.

FIG. 14 is an example in which the DMC 1400 plays a content provided by the DMS 150 in the DMR 1450.

The DMR 1450 is a device capable of playing a content in accordance with an operation of the DMC 1400.

The DMC 1400 detects the DMR 1450 and the DMS 150 by the UPnP device find function. If a device detected from the device information is the DMS 150, the DMC 1400 determines whether one or both of the resume information acquiring action “X_GetResumePoint” and the resume information setting action “X_SetResumePoint” is supported, or that is to say, whether the resume function is available, from the service information sent from the DMS 150.

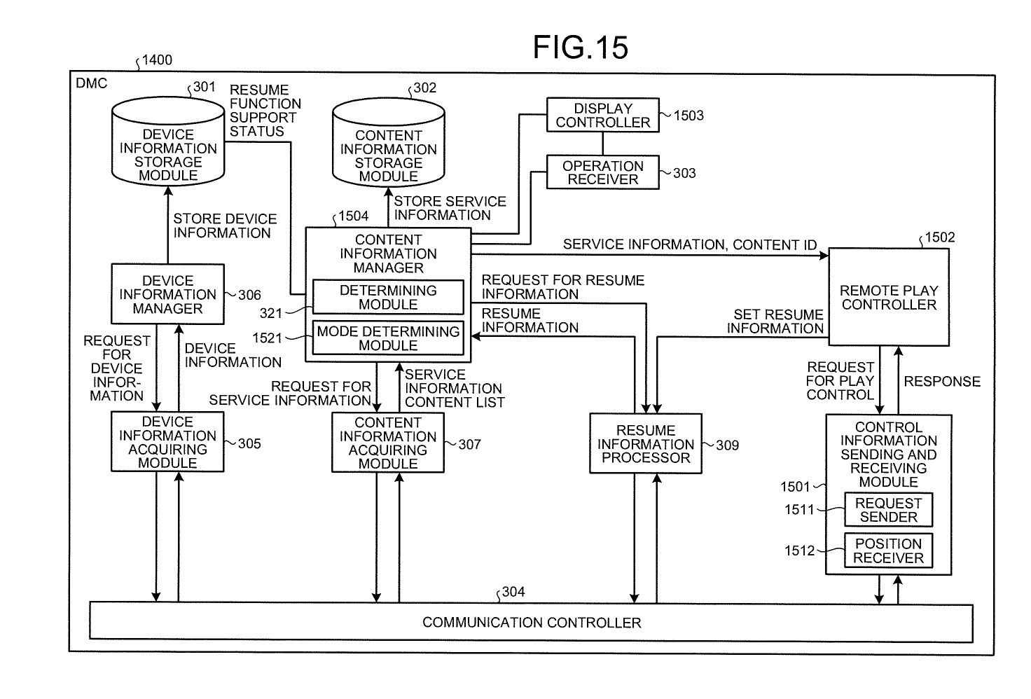

First, a configuration of the DMC 1400 is explained. FIG. 15 is a block diagram illustrating a software configuration of the DMC 1400. As illustrated in FIG. 15, in comparison to the DMP 100 according to the aforementioned first embodiment, in the DMC 1400 according to the present embodiment, the content information manager 308 is changed to a content information manager 1504 which performs different process, the content reproduction controller 310 and the stream controller 311 are removed, and a remote play controller 1502 and a control information sending and receiving module 1501, and a display controller 1503 are added. In the following explanations, configuration elements that are the same as that of the first embodiment are referred to by the same reference numerals, and the explanations thereof are omitted.

The display controller 1503 controls a display (for example, liquid crystal panel) comprised in the DMC 1400 to display data.

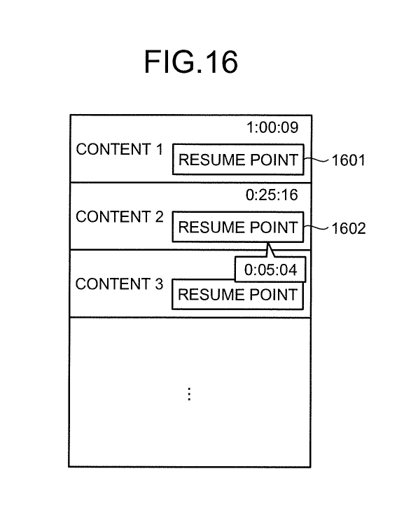

The display controller 1503 can control displaying the content list acquired from the DMS 150. FIG. 16 is a diagram illustrating a screen example of the content list to be displayed by the display controller 1503 according to the present embodiment. As illustrated in FIG. 16, the resume point buttons 1601, 1602 are provided for each content.

If the operation receiver 303 receives the press down of the resume point button 1602, the resume point of the content is displayed. In the example illustrated in FIG. 16, the resume point is displayed in association with the content 2 as a popup, but not so limited. The resume point can be displayed for all of the contents. As similar to that of the first embodiment, the resume point displayed in FIG. 16 is assumed to be based on the resume information acquired by the resume information processor 309, thereby the explanations thereof are omitted.

Conventionally, the DMC displays only the content list, thereby it cannot be determined whether each content is viewed or whether each content is viewed until the end. In comparison, according to the present embodiment, the resume point confirmation button is arranged on the display screen. Accordingly, it becomes possible to confirm the resume point of each content by pressing down the button and displaying the resume point. Thus, it is possible to recognize the viewing condition without playing the content and the like. Here, the resume point confirmation button is not limited to be arranged on the display screen, and it may be arranged on the remote controller.

The remote play controller 1502 controls a DMR (for example, the DMR 1450) to play the content.

The control information sending and receiving module 1501 comprises a request sender 1511 and a position receiver 1512. The control information sending and receiving module 1501 sends and receives information for controlling the stream played by the DMR.

If the operation receiver 303 receives an operation to play the content at the DMR (for example, the DMR 1450), the request sender 1511 requests the DMR to play the content from the resume point indicated by the resume information.

If the operation receiver 303 receives an operation to stop playing the content with respect to the DMR 1450, the position receiver 1512 receives the resume point at which the content is stopped, from the DMR 1450.

Then, upon receipt of the resume point by the position receiver 1512, the resume information processor 309 sends the resume information containing the resume point to the DMS 150.

The content information manager 1504 further comprises a mode determining module 1521, in addition to the determining module 321. Other than that, the content information manager 1504 is the same as the content information manager 308 of the first embodiment, thereby the explanations thereof are omitted.

The DMC 1400 according to the present embodiment is provided with a secret mode. The secret mode is a mode to inhibit setting the resume point at which the content played by the operation of the DMC 1400 is stopped, for the DMS 150.

If the content is desired to be shared by a plurality of users via the DMS 150 but the status of whether the content is viewed is desired to be hidden for others, the other users can recognize who viewed the content because the resume point of the DMS 150 is updated.

Thus, in the DMC 1400 according to the present embodiment, it is made selectable whether to set the resume point to the DMS 150. In the DMC 1400 according to the present embodiment, the operation receiver 303 receives the selection of whether the resume point is to be set to the DMS 150. Here, a setting button to enable/disable the secret mode can be arranged on a screen displayed by the DMC 1400. Then, for example, if it is desired to switch the destination at which the content is to be played, upon receipt of the press down operation of the setting button, the DMC 1400 can send the action “X_SetResumePoint” for setting the resume point, to the DMS 150. A flag representing whether the secret mode is selected is stored in the content information storage module 302.

If the secret mode has been selected, the DMC 1400 stores the resume point, which is a result of playing the content, in the content information storage module 302 within the DMC 1400. If the secret mode has not been selected, the resume point is updated by that of after the playing, in the DMS 150, as similar to the first embodiment. Then, upon receipt of an operation to switching between the secret mode and not, the operation receiver 303 updates the flag stored in the content information storage module 302, which indicates whether the secret mode is selected.

Then, the mode determining module 1521 according to the present embodiment refers to the content information storage module 302, and determines whether the secret mode is selected.

If the mode determining module 1521 determines that it is not the secret mode, the resume information processor 309 sends the resume information containing the resume point received by the position receiver 1512, to the DMS 150.

On the other hand, if the mode determining module 1521 determines that it is the secret mode, the content information manager 1504 stores the resume point in the content information storage module 302, in association with the content ID. Consequently, when the DMC 1400 is used to play the content, it becomes possible to play the content from the resume point.

Referring back to FIG. 14, a detailed process is explained. The DMC 1400 acquires the content list from the DMS 150 (S1401). Then, the DMC 1400 receives a selection of a content desired to be viewed by a user, from the acquired content list. The DMC 1400 then determines whether the resume function is supported, based on the service information from the DMS 150. If it is determined that the resume function is supported, the resume point of the selected content is acquired from the DMS 150 (S1402).

Then, the request sender 1511 of the DMC 1400 notifies the DMR 1450 of the action “AVT: SetAVTransportURI” containing the content ID indicating the selected content (S1403). Consequently, the information of the content to be played can be set with respect to the DMR 1450.

Then, the request sender 1511 notifies the DMR 1450 of the action “AVT: Seek” for setting the resume point (S1404).

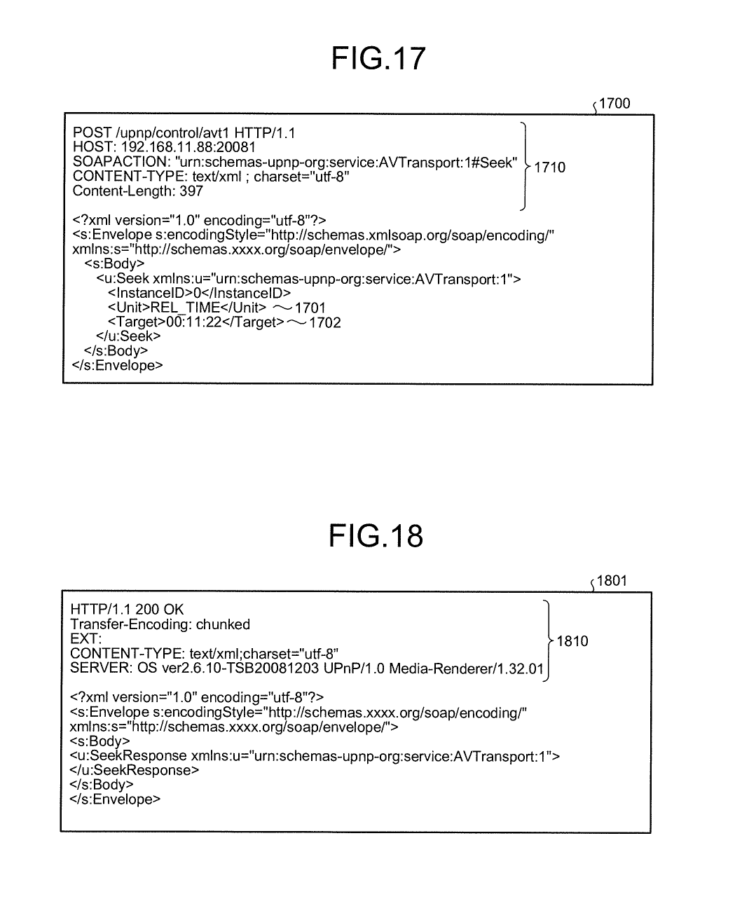

FIG. 17 is a diagram illustrating an example of the action “AVT: Seek”. As illustrated in FIG. 17, the action “AVT: Seek” is configured by a header 1710 and a body in the XML. Within the tag “u”, a seek destination, or in other words the resume point from which the content is to be played, is set as the tag “REL_TIME” 1701 and the tag “TARGET” 1702. By this notification, it becomes possible to play the content from the resume point, at the DMR 1450 side.

After the action is notified, the DMR 1450 notifies the DMC 1400 of a response that the request has been received.

FIG. 18 is a diagram illustrating an example of the response for the action “AVT: Seek”. As illustrated in FIG. 18, the response for the action “AVT: Seek” is configured by a header 1810 and a body in the XML. Within the tag “u”, “SeekResponse” is indicated. That is to say, within the tag “u”, it is indicated that it is a response to the action “AVT: Seek”. In view of the response, the DMC 1400 can confirm that the action “AVT: Seek” is appropriately performed.

The request sender 1511 of the DMC 1400 requests the DMR 1450 to play the content via the action “AVT: Play” (S1405). According to the request, the DMR 1450 sends the HTTP GET request in which the resume point from which the content is to be played is contained in the RANGE header, to the DMS 150 (S1406). Accordingly, the DMS 150 sends a stream of content from the resume point to the DMR 1450 (S1407). Consequently, the DMR 1450 plays the stream.

If the DMR can use the action “AVT: Seek” only after performing the action “AVT: Play” in comparison to the present embodiment, the DMC may execute the action “AVT: Seek” after the action “AVT: Play”.

The request sender 1511 of the DMC 1400 requests the DMR 1450 to stop playing the content, via the action “AVT: Stop” (S1408). Accordingly, the DMR 1450 stops playing the content. Thus, the distribution of the content from the DMS 150 is stopped.

Next, when the user operates the DMC 1400 to stop playing the content while the DMS 150 supports the resume function, the point where the content is stopped is set as the resume information. In the present embodiment, it is assumed that the DMS 150 is provided with the resume function. As one of the method to determine the resume point, a timer may be provided to the DMC 1400 side. In this case, the point of stop of the content may be determined from play elapsed time, and the point of stop of the content maybe acquired by the action “AVT: GetPositionInfo” from the DMR 1450. The example illustrated in FIG. 14 uses the action “AVT: GetPositionInfo”.

In this case, the position receiver 1512 of the control information sending and receiving module 1501 notifies the DMR 1450 of the action “AVT: GetPositionInfo”. Accordingly, the DMR 1450 sends the point where the content is stopped, i.e., the resume point, to the DMC 1400 (S1409). Consequently, the position receiver 1512 can receive the resume point.

Subsequently, the resume information processor 309 sends the request “X_SetResumePoint” for setting the received resume point, to the DMS 150 (S1410). Accordingly, the DMS 150 updates the resume point in association with the content ID. Then, the DMS 150 notifies the DMC 1400 of the response “SetResumePointResponse”. Thus, the resume point is appropriately updated.

Although differing from the present embodiment, the content can be stopped playing by the action “AVT: Stop”, after acquiring the point where the content is stopped via the action “AVT: GetPositionInfo”.

Furthermore, if the operation is performed from an external device such as a remote controller of the DMR 1450, or if the content is stopped due to an operation other than the operation of the DMC 1400, the DMC 1400 determines the point where the content is stopped by using the timer function of the DMC 1400. Then, the DMC 1400 can send the request “X_SetResumePoint” to the DMS 150 to set the point where the content is stopped as the resume point.

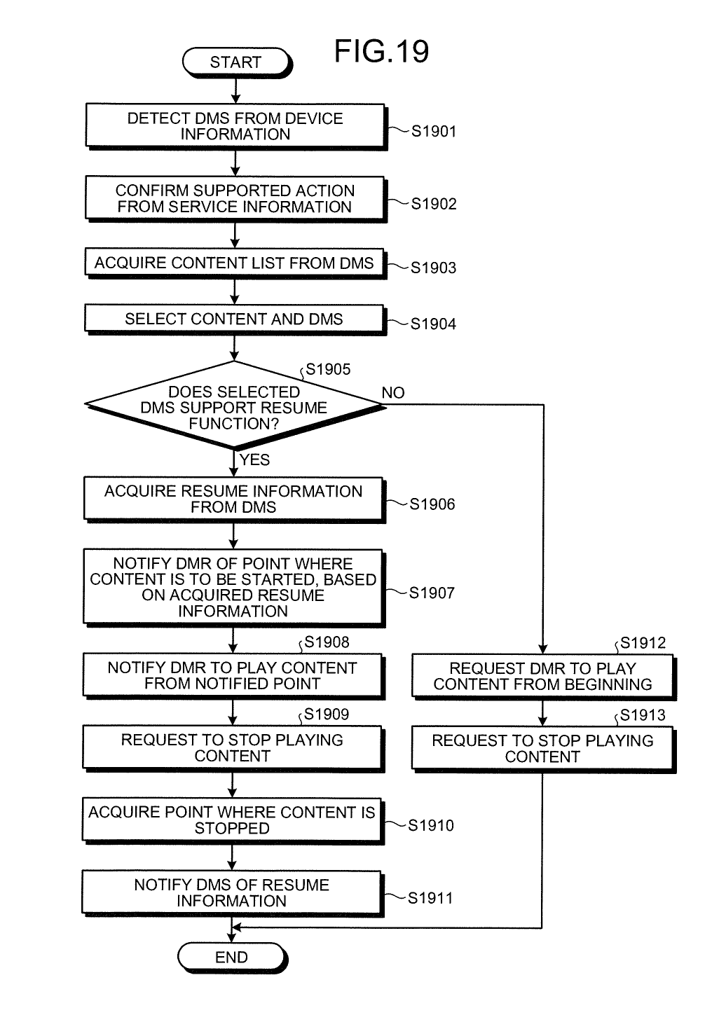

Next, an overall process of the DMC 1400 according to the present embodiment is explained. FIG. 19 is a flowchart illustrating the aforementioned process in the DMC 1400 according to the present embodiment. In the flowchart, the secret mode is not set.

As similar to S701 to S705 in FIG. 7, the process for determining whether the DMS 150 supports the resume function is performed (S1901 to S1905).

Then, if the determining module 321 determines that the resume function is not supported by the DMS 150 (No at S1905), the content information manager 1504 passes the service information and the content ID to the remote play controller 1502. Accordingly, by an instruction from the remote play controller 1502, the control information sending and receiving module 1501 requests the DMR 1450 to play the content indicated by the received content ID from the beginning. Then, the DMR 1450 plays the stream of content represented by the content ID from the beginning.

If the operation receiver 303 receives the operation to stop playing the content, the request sender 1511 requests the DMR 1450 to stop playing the stream of content (S1913). Accordingly, the transferring of the content which is currently being played is stopped.

On the other hand, if the determining module 321 determines that the resume function is supported (Yes at S1905), the resume information processor 309 requests the DMS 150 for the resume information by using the action “X_GetResumePooint”. Accordingly, the resume information processor 309 acquires the resume information from the DMS 150 (S1906). Then, the resume information is passed to the content information manager 1504. Then, the content information manager 1504 passes the resume information to the remote play controller 1502, together with the service information and the content ID. Accordingly, the remote play controller 1502 requests the control information sending and receiving module 1501 to play the stream.

Then, based on the acquired resume information, the request sender 1511 of the control information sending and receiving module 1501 notifies the DMR 1450 of the action “AVT: Seek” to which the resume point where the content is to be played is contained (S1907).

Then, the control information sending and receiving module 1501 notifies the DMR 1450 of the action “AVT: Play” to play the content from the notified resume point (S1908).

If the operation receiver 303 receives the operation to stop playing the content, the request sender 1511 of the control information sending and receiving module 1501 requests the DMR 1450 to stop playing the content via the action “AVT: Stop” (S1909). Thus, the transferring of the content currently being played is stopped.

Then, the request sender 1511 notifies the DMR 1450 of the action “AVT: GetPositionInfo”. Accordingly, the DMC 1400 acquires a point where the content is stopped from the DMR 1450 (S1910).

Then, the resume information processor 309 notifies the DMS 150 of the resume information with the resume point as the point where the content is stopped (S1911).

By the aforementioned process, it becomes possible to play the content from the resume point, and to set the resume point after the content is played. Besides, the DMC 1400 has effects similar to that of the DMP 100.

If the resume point is updated only when the content is stopped, it might be a case that the resume point cannot be set due to the network shutdown during playing of the content. Thus, the action “X_SetResumePoint” for setting the resume point may constantly be executed during the playing of the content, to update the resume information. Consequently, the content can be played from the resume point without being aware of the terminal which plays the content.

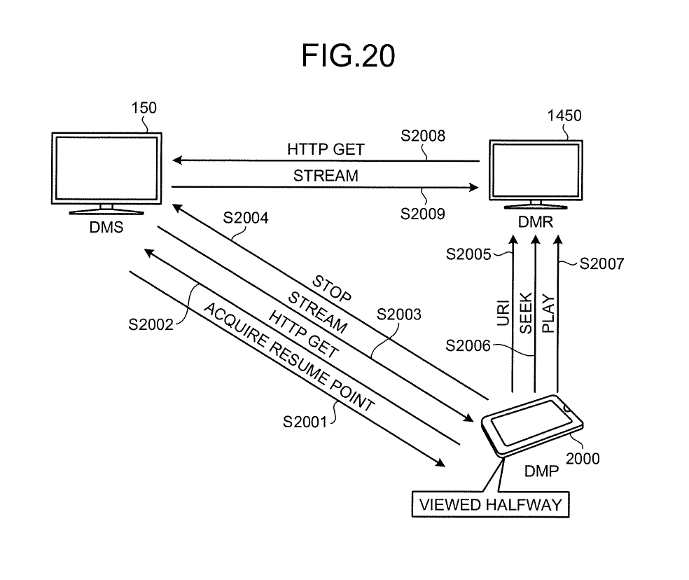

A third embodiment explains a case when a device for playing the content is switched to other device. FIG. 20 is a diagram illustrating a home network configuration connecting devices, according to the third embodiment. As illustrated in FIG. 20, the present embodiment is configured by the DMS 150, the DMR 1450, and a DMP 2000. Configurations the same as that of the first and the second embodiments are referred to by the same reference numerals, and explanations thereof are omitted.

DMP 2000 has both a content playing function of the DMP and the playing controlling function of the DMC. The DMP 2000 can switch the destination for playing the content between the DMP 2000 and the DMR 1450.

The present embodiment is an example that the content provided from the DMS 150 and played by the DMP 2000 is to be played by the DMR 1450. Here, although differing from the present embodiment, the content being played by the DMR 1450 can be played by the DMP 2000.

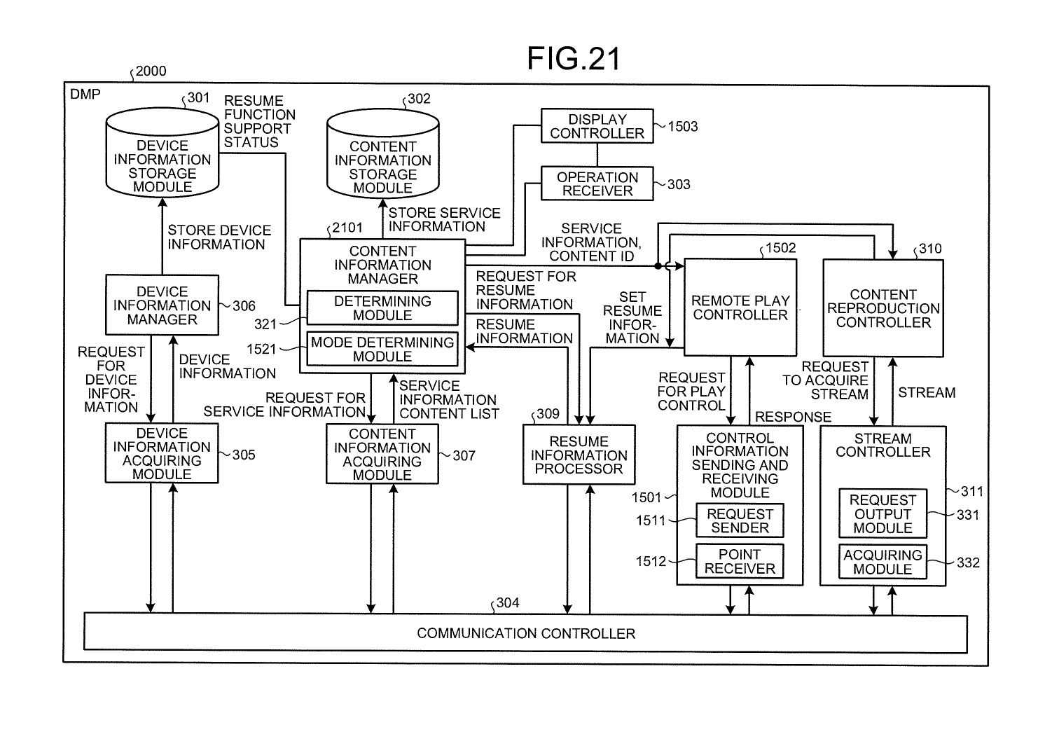

FIG. 21 is a block diagram illustrating a software configuration of the DMP 2000 according to the present embodiment. As illustrated in FIG. 21, the DMP 2000 according to the present embodiment differs from the DMP 100 according to the aforementioned first embodiment in that, the content information manager 308 is changed to a content information manager 2101 which perform process different from that of the content information manager 308, and that the remote play controller 1502, the control information sending and receiving module 1501, and the display controller 1503 of the second embodiment are added.

That is to say, the DMP 2000 according to the present embodiment has the configuration of the DMP 100 of the first embodiment and the configuration of the DMC 1400 of the second embodiment, thereby the content can be played within itself as well as a request to play the content can be made with respect to the DMR 1450.

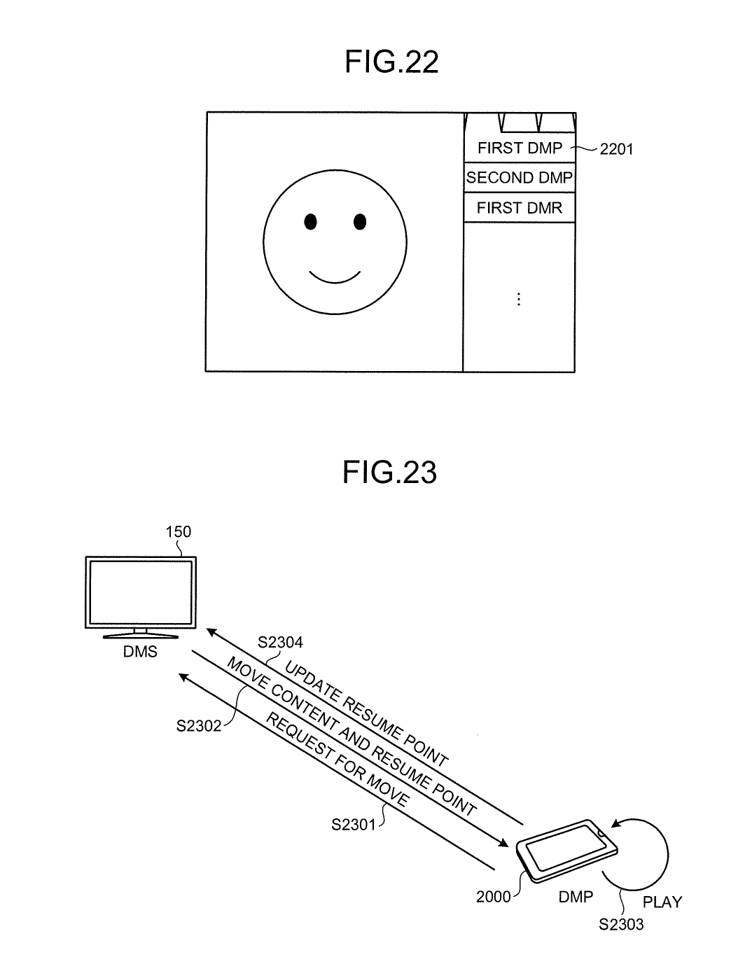

The display controller 1503 can control displaying of the list of devices, which are to be destinations of displaying the content. FIG. 22 is an example of the list of devices, which are the destinations of displaying the content, displayed by the display controller 1503. As illustrated in FIG. 22, the display controller 1503 can display the list 2201 of a device to be switched to, to play the content while controlling the displaying of the content. Among the list of the devices, the “first DMP” represents the DMP 2000, and other devices are based on the device information read out from the device information storage module 301.

If the operation receiver 303 receives the selection of a device to be switched to, displaying of the content can be restarted from the point upto where the DMP 2000 played, at the device switched to. In the present embodiment, the displaying of the content is switched without updating the resume point of the DMS 150.

Referring back to FIG. 21, the content information manager 2101 manages the list of content and the service information. Further, if the operation receiver 303 receives the selection of other device, the content information manager 2101 switches the output destination of the service information, the content ID, and the like, from the content reproduction controller 310 to the remote play controller 1502.

Further, if the operation receiver 303 receives an operation to switch the destination of displaying the content from other device to the DMP 2000, the content information manager 2101 switches the output destination of the service information, the content ID, and the like, from the remote play controller 1502 to the content reproduction controller 310.

Referring back to FIG. 20, a detailed process is explained.

First, the DMP 2000 acquires a resume point of a target content from the DMS 150 (S2001).

The request output module 331 of the DMP 2000 then notifies the DMS 150 of the HTTP GET request in which the resume point from where the content is to be played is included in the RANGE header (S2002).

Then, the acquiring module 332 of the DMP 2000 acquires the stream of content from the resume point, from the DMS 150 (S2003). Accordingly, the content reproduction controller 310 plays the stream of the acquired content.

Subsequently, if the operation receiver 303 receives the operation to switch the destination of playing the content from the DMP 2000 to the DMR 1450, the stream controller 311 stops playing the stream of content. Then, the DMP 2000 stops the transferring of the content currently being played from the DMS 150 (S2004). Here, as described above, the resume point is not notified to the DMS 150.

Then, the content information manager 2101 acquires the resume point where the content is stopped from the content reproduction controller 310. The content information manager 2101 then stores the resume point in the content information storage module 302, in association with the object ID of the stopped content. The stream with respect to the DMS 150 is disconnected.

Then, the request sender 1511 of the DMP 2000 notifies the DMR 1450, which is a destination at which the content is to be played, of the action “AVT: SetAVTransportURI” containing the content ID of the content, which is continued to be viewed (S2005). Thus, the content information to be played can be set for the DMR 1450.

The request sender 1511 notifies the DMR 1450 of the action “AVT: Seek” for setting the resume point where the content is stopped in the DMP 2000 (S2006). After the action is notified, the DMR 1450 notifies the DMP 2000 of a response that the request is received.

The request sender 1511 of the DMP 2000 requests the DMR 1450 to play the content, via the action “AVT: Play” (S2007).

By the request, the DMR 1450 sends the HTTP GET request in which the resume point from where the content is to be played is contained in the RANGE header, to the DMS 150 (S2008). Accordingly, the DMS 150 sends the stream of content from the resume point to the DMR 1450 (S2009). Consequently, the DMR 1450 plays the stream.

As described above, in the present embodiment, when the destination of playing the content is switched, the resume point can be turned over to the destination without updating the resume point in the DMS 150. Here, if the playing of the content is not to be continued in the DMR 150 and the DMP 2000, the resume point may be stored in the DMS 150, as similar to the first and the second embodiments.

In the third embodiment, because there is provided the aforementioned configuration, the resume point can be turned over between the devices for playing the content, without storing the resume point in the DMS 150. Therefore, it becomes possible to quickly switch the terminal for playing the content.

In the aforementioned embodiment, the streaming transferred from the DMS 150 is played. However, playing of the streaming is not limited thereto. That is to say, the content can be carried out, and the content can be played based on the resume point at a location away from the DMS 150.

According to the present embodiment, the content managed by the DMS 150 is copied by or moved to the DMP 2000, and the content is played at the DMP 2000. FIG. 23 is a diagram illustrating a home network configuration connecting devices according to a fourth embodiment. As illustrated in FIG. 23, the present embodiment is configured by the DMS 150 and the DMP 2000. The configuration of the DMS 150 and the DMP 2000 are the same as that of the third embodiment, thereby the explanations thereof are omitted.

As illustrated in FIG. 23, the request output module 331 of the DMP 2000 requests the DMS 150 to copy or move the content (S2301). Accordingly, the DMS 150 copies the content to or move the content to the DMP 2000 (S2302). At this time, the resume information processor 309 of the DMP 2000 sends the request “CDS: X_GetResumePoint” to the DMS 150. In response, the DMS 150 sends the resume information “ResumePoint” containing the resume point corresponding to the object ID representing the object copied or moved.

Thus, the DMP 2000 can acquire the content and the resume point. The content reproduction controller 310 of the DMP 2000 controls playing of the content within the DMP 2000 from the resume point (S2303). If the content is stopped, the content information manager 2101 stores the point where the content is stopped in the content information storage module 302 as the resume point.

Upon receipt of the operation to reflect the resume point from the user to the DMS 150, the DMP 2000 sends the resume information containing the resume point readout from the content information storage module 302 by the resume information processor 309, to the DMS 150 (S2304). Here, the DMP 2000 can move the content from or copy the content from the DMS 150.

Consequently, DMS 150 can manage the resume point upto where the DMP 2000 played the content, in association with the content ID.

Conventionally, when the content is played, it is required that all of the devices are provided with the resume function and the resume information is acquired from all of the terminals. In comparison, according to the aforementioned embodiment, it is not required to obtain the resume information of all of the devices because it is only required to select a server (for example, DMS 150) to which the content is transferred at the time when the content is selected, thereby the time it takes for acquiring the content is reduced.

Further, according to the aforementioned embodiment, when the content is played, it is determined whether the DMS is provided with the resume function. Thus, the resume function is not required to be provided to all of the DMSs connected to the home network, thereby it becomes more convenient.

As described in the above embodiment, the resume function can easily be used even when the DLNA function is used.

The content processing program executed by the DMS, the DMP, and the DMC of the aforementioned embodiments can be configured so as to be preliminarily stored in the ROM and the like and provided.

The content processing program executed in the DMS, the DMP, and the DMC of the embodiments has a module configuration comprising the aforementioned elements. As an actual hardware, the CPU (processor) reads out the content processing program from the above storage medium, and executes the program. Accordingly, the aforementioned elements are loaded onto the RAM, and generated on the RAM.

The content processing program executed in the DMS, DMP, and the DMC of the embodiments can be configured so as to be stored in a computer-readable storage medium, such as a compact disk read only memory (CD-ROM), a flexible disk (FD), a compact disk recordable (CD-R), a digital versatile disk (DVD), and the like, in an installable or executable format, and provided.

Further, the content processing program executed by the DMS, the DMP, and the DMC of the embodiments can be configured so as to be stored in a computer connected to a network such as the Internet, and provided by downloading via the network. Still further, the content processing program executed in the DMS, the DMP, and the DMC of the embodiments can be configured so as to be provided or distributed via a network such as the Internet.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content processor comprising:
an information acquiring module configured to acquire, from a content sending device configured to provide a content by a universal plug and play (UPnP) function, command information representing a command executable by the content sending device;
a determining module configured to determine whether the content sending device is provided with a resume function for the content based on the command information;
a resume information acquiring module configured to acquire, if the determining module determines that the content sending device is provided with the resume function, resume information indicating a point where the content being played is stopped, from the content sending device;
a content request module configured to output a request for transferring the content from the point indicated by the resume information acquired by the resume information acquiring module; and
a content acquiring module configured to acquire, from the content sending device, the content transferred from the point.

2. A content processor comprising:
a resume information acquiring module configured to acquire, from a content sending device configured to provide a content by a universal plug and play (UPnP) function, resume information indicating a point where a content being played is stopped; and
a play request module configured to request a content playing device to acquire the content from the point from the content sending device, and to play the acquired content.

3. The content processor of claim 2, further comprising:
a receiver configured to receive an operation to stop playing the content;
a position acquiring module configured to acquire, upon receipt of the operation to stop playing the content by the receiver, a point where the content is stopped, from the content playing device; and
a resume information output module configured to output the resume information indicating the point acquired by the point acquiring module to the content sending device.

4. The content processor of claim 2, further comprising:
an information acquiring module configured to acquire, from the content sending device, command information representing a command executable by the content sending device, with a universal plug and play (UPnP) function; and
a determining module configured to determine whether the content sending device is provided with a resume function for the content based on the command information, wherein,
if the determining module determines that the content sending device is provided with the resume function, the resume information acquiring module acquires the resume information.

5. The content processor of Claim 3, further comprising a mode determining module configured to determine whether a user operable secret mode is set, the secret mode inhibiting the resume information output module from providing the point where the content is stopped to the content sending device, wherein,
if it is determined that the secret mode is not set, the resume information output module outputs the resume information to the content sending module.

6. The content processor of claim 5, further comprising a storage module configured to store therein, if the mode determining module determines that the secret mode is set, the resume information indicating the point where the content is stopped.

7. The content processor of claim 2, further comprising a display module configured to display the point indicated by the resume information acquired by the resume information acquiring module in association with the content.

8. A content processor comprising:
a content playing module configured to play a content transferred from a content sending device configured to provide a content by a universal plug and play (UPnP) function;
a stop request module configured to request the content sending device to stop transferring the content being played;
a position notifying module configured to notify a content playing device playing content, of a point where the content is stopped by the stop request module; and
a play request module configured to request the content playing device to play the content from the notified point.

9. The content processor of claim 8, further comprising:
a receiver configured to receiver an operation to stop playing the content by the content playing device;
a point acquiring module configured to acquire, if the receiver receives the operation to stop playing the content, the point where the content is stopped, from the content playing device; and
a resume information output module configured to output the point acquired by the position acquiring module to the content sending device as the resume information.
